(19) United States
(12) Patent Application Publication
(10) Pub. No.: US 2008/0055231 A1
(43) Pub. Date: Mar. 6, 2008

(54) Mobile terminal and display panel driver

(75) Inventors: Takashi Nose, Kanagawa (JP); Hirobumi Furihata, Kanagawa (JP); Kentaro Hayashi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/892,924

(22) Filed: Aug. 28, 2007

(30) Foreign Application Priority Data
Aug. 30, 2006 (JP) 233260/2006
Jul. 13, 2007 (JP) 183870/2007

(51) Int. Cl. G09G 3/36

(52) U.S. Cl. 345/102; 455/566

(57) ABSTRACT

To provide a technique for protecting a fast interface for transferring image data among a plurality of cases from noise caused by controlling of the brightness of the backlight. The mobile terminal according to the present invention has a body case 1, a display part case 2, a coupling mechanism 3 for coupling them, a CPU 11, an LCD panel 13, a controller driver 15 for driving the LCD panel 13, a backlight 17 and a backlight driver 16. The CPU 11 is mounted to the body case 1, while the LCD panel 13, the controller driver 15, the backlight 17 and the backlight driver 16 are mounted to the display part case 2. The controller driver 15 drives the LCD panel 13 in response to the image data received from the CPU 11 via an interface signal line 18, while supplying the brightness control signal 21 for controlling the backlight 17 to the backlight driver 16.

### BACKGROUND OF THE INVENTION

1. Field of the Invention

The present invention relates to a mobile terminal, and more specifically to a mobile terminal with a display device using a backlight (for example, a liquid crystal display device) mounted thereon.

2. Description of the Related Art

One of the issues raised in developing a mobile phone or the other mobile terminals is to reduce power consumption of a liquid crystal display device. The power consumption for the liquid crystal display device, particularly for a backlight, occupies a significant part of the entire of the mobile terminal. Therefore, there has been strongly needed to reduce the power consumption of the backlight.

One of the means for reducing the power consumption of the backlight is to control driving current or driving voltage supplied to the backlight. If an image can be displayed in a good condition even when the backlight has low brightness, the driving current/driving voltage supplied to the backlight can be reduced to reduce the brightness of the backlight so that the power consumption of the backlight can be reduced.

For example, Japanese Patent Laid-Open No. 2005-148708 discloses a liquid crystal display device for controlling the brightness of the backlight (i.e., the driving current/driving voltage supplied to the backlight) according to image data for displayed image. In the liquid crystal display device, a histogram of grayscale of each pixel of each frame image is calculated, and the brightness of the backlight is controlled in accordance with the calculated histogram.

On the other hand, Japanese Patent Laid-Open No. 2003-161926 discloses a mobile terminal for controlling the brightness of the backlight in accordance with luminance of outside light. The mobile terminal stops supplying power to the backlight when the luminance of outside light is larger than a first threshold, lights the backlight with a first power value when the luminance of outside light is lower than the first threshold and larger than a second threshold, and lights the backlight with a second power value lower than the first power value when the luminance of outside light is lower than the second threshold.

Another issue raised in developing a mobile terminal is the techniques for mounting a circuit to the mobile terminal, such as a folding mobile phone, that is made from a plurality of cases connected by a coupling mechanism (for example, a hinge). Most typically, such a mobile terminal has a CPU (central processing unit) mounted to one of the cases and has an LCD panel, an LCD driver, and a backlight mounted to the other case. Image data is transmitted from the CPU to the LCD driver via a FPC (flexible printed circuit) embedded in the coupling mechanism. The abovementioned Japanese Patent Laid-Open No. 2003-161926 discloses a folding mobile phone with a first case having an optical sensor, a receiver, an antennae and a translucent liquid crystal display device mounted and a second case having an operational switch and a microphone mounted.

In most cases, a coupling mechanism for coupling a plurality of cases cannot have many signal lines mounted inside. Therefore, a fast interface, which can quickly transmit data via a small number of wires, is adopted to transmit image data from the CPU to the LCD driver mounted to different cases. The serial interface technique using differential signals such as the LVDS (Low Voltage Differential Signaling), the RSDS™ (Reduced Swing Differential Signaling) or Mobile CMADS™ (Mobile current Mode Advanced Differential Signaling) is a typical fast interface used in transmitting image data from the CPU to the LCD driver. As both the number of pixels and the number of grayscales of the LCD panel have increased, a required data transfer rate has been further increasing.

A problem in such a mobile terminal is that the fast interface is not much resistant to noise. As the fast interface transmits small-amplitude signals at a fast data transfer rate, it is largely affected by noise.

As inventors studied, that problem of noise affecting the fast interface is serious particularly when the brightness of the backlight is controlled. When the brightness of the backlight is controlled, the driving current/driving voltage supplied to the backlight needs to be changed. If the power source line for supplying the driving current/driving voltage to the backlight is placed near to the signal lines of the fast interface, the signal lines of the fast interface may be affected by noise. When the driving current/driving voltage are generated by the PWM (pulse width modulation) in particular, the driving current/driving voltage has a pulse waveform. That cases the noise applied to signals of the fast interface.

With such a background, there has been needed for a technique for protecting the fast interface that transfers image data between a plurality of cases from noise generated by controlling the brightness of the backlight.

### SUMMARY OF THE INVENTION

An object of the present invention is to provide a technique for protecting a fast interface for transferring image data among a plurality of cases from noise caused by controlling of the backlight.

In order to solve the abovementioned problem, the present invention adopts the means as described below. The description of technical matters forming the means includes numbers and codes used in “DETAILED DESCRIPTION OF THE PREFERRED EMBODIMENTS” for clarifying correspondence between the description of “What is claimed is” and the description of “DETAILED DESCRIPTION OF THE PREFERRED EMBODIMENTS”. The numbers and codes included, however, should not be construed for limitedly interpreting the technical range of the invention described in “What is claimed is”.

A mobile terminal according to the present invention includes a first case (1), a second case (2), a coupling mechanism (3) for movably coupling the first case (1) and the second case (2), an image data generating part (11) for generating image data, a display panel (13), a display panel driver (15) for driving the display panel (13) in response to the image data, a backlight (17) for illuminating the display panel (13), and a driving circuit (16) for driving the backlight (17). The image data generating part (11) is mounted to the first case (1). On the other hand, the display panel (13), the display panel driver (15), the backlight (17) and the driving circuit (16) are mounted to the second case (2). The display panel driver (15) is adapted to receive the image data from the image data generating part (11) via a signal line (18) that is placed through the coupling mechanism (3), and drive the display panel (13) in response to the received image data, while supplying a brightness control signal (21) for controlling the brightness of the backlight (17) to the driving circuit (16).

In the mobile terminal with such configuration, neither a power source line for supplying the driving current/voltage from the driving circuit (16) to the backlight (17) nor a signal line for supplying the brightness control signal (21) needs not to be provided along with the signal line (18) for transmitting image data from the image data generating part (11) to the display panel driver (15). That configuration can reduce the noise from the signal line (18) for transmitting the image data.

According to the present invention, a technique for protecting a fast interface for transferring image data among a plurality of cases from noise caused by controlling of the brightness of the backlight can be provided.

### BRIEF DESCRIPTION OF THE DRAWINGS

FIG. 1 is an overhead view showing configuration of a mobile terminal in an embodiment of the present invention;

FIG. 2 is a block diagram showing configuration of the mobile terminal shown in FIG. 1;

FIG. 3 is a block diagram showing configuration of a control driver mounted to the mobile terminal shown in FIG. 2;

FIG. 4 is a block diagram showing an embodiment of a mobile terminal with two cases as a precondition of the present invention;

FIG. 5 is a block diagram showing another embodiment of a mobile terminal with two cases as a precondition of the present invention;

FIG. 6 is a block diagram showing configuration of a brightness control circuit of the controller driver shown in FIG. 3;

FIG. 7 is a timing chart showing operations of a PWM waveform generating circuit of the brightness control circuit shown in FIG. 6;

FIG. 8 is a diagram showing operations of the brightness control circuit in the image setting mode;

FIG. 9 is a diagram showing operations of the brightness control circuit in the outside light setting mode;

FIG. 10 is a diagram showing operations of the brightness control circuit in the image/outside light setting mode;

FIG. 11 is a block diagram showing an embodiment of the mobile terminal with two cases as a precondition of the present invention;

FIG. 12 is a block diagram showing another embodiment of the mobile terminal with two cases as a precondition of the present invention; and

FIG. 13 is a block diagram showing another configuration of the mobile terminal shown in FIG. 1.

### DETAILED DESCRIPTION OF THE PREFERRED EMBODIMENTS

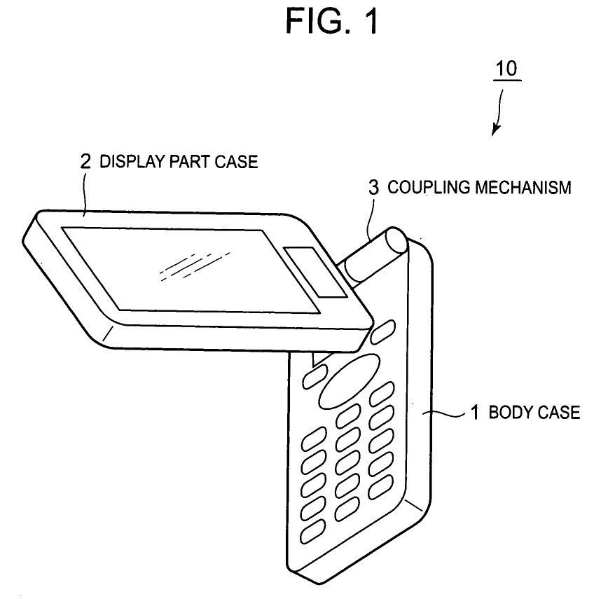

FIG. 1 is a diagram showing an external view of a mobile terminal 10 of an embodiment of the present invention. The mobile terminal 10 includes two cases of a body case 1 and a display part case 2. The body case 1 and the display part case 2 are coupled by a coupling mechanism 3 so as to be movable to each other. In the embodiment, the body case 1 is coupled rotatably on an axis orthogonal to a surface of the display part case 2.

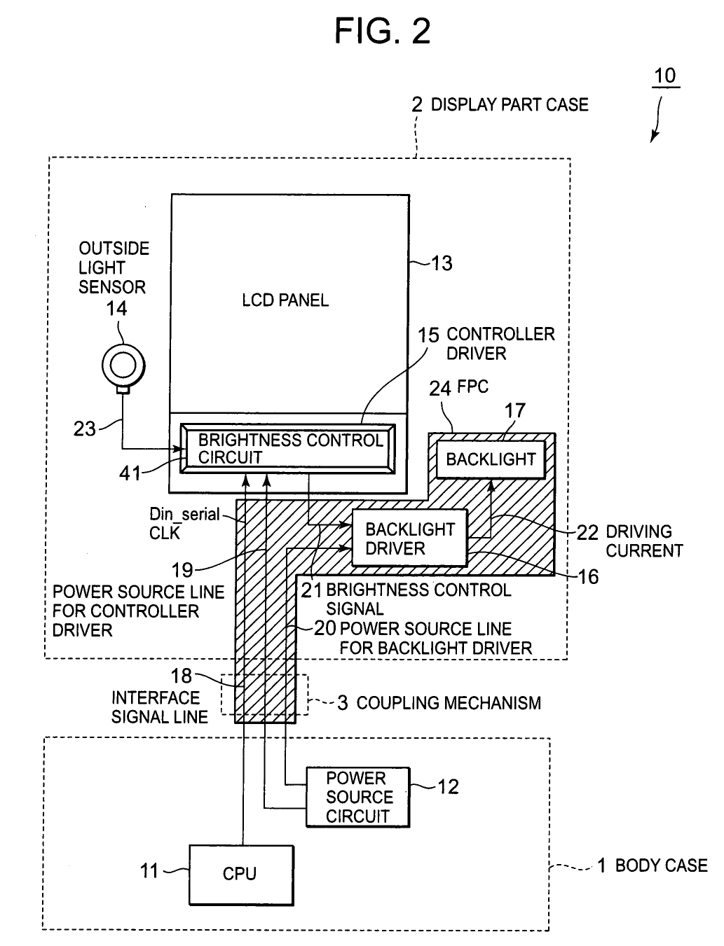

FIG. 2 is a block diagram showing implementation of a circuit in the mobile terminal 10. The body case 1 has a CPU (image data generating part) 11 and a power source circuit 12 mounted to a multilayer printed wiring board (hereinafter referred to as a PWB). The display part case 2 has an LCD panel 13, an outside light sensor 14, a controller driver (display panel driver) 15, a backlight driver (a driving circuit for driving a backlight) 16 and a backlight 17 for illuminating the LCD panel 13 mounted. In the embodiment, the controller driver 15 is mounted on a glass board of the LCD panel 13 by using the COG (chip on glass) technique. The controller driver 15 may be made of a plurality of LSIs on a glass board.

The CPU 11 is connected with the controller driver 15 via an interface line 18, which is placed through the coupling mechanism 3 for coupling the body case 1 and the display part case 2. The CPU 11 supplies serial image data Din_serial and a differential clock signal CLK to the controller driver 15 by using a fast interface technique (for example, a fast serial interface technique such as the LVDS, the RSDS™ and the Mobile CMADS™ using a small-amplitude difference signal.

The power source circuit 12 supplies direct current to the controller driver 15 and the backlight driver 16. The direct-current power is supplied from the power source circuit 12 to the controller driver 15 via a power source line for controller driver 19, which is placed through the coupling mechanism 3. Similarly, the direct-current power is supplied from the power source circuit 12 to the backlight driver 16 via a power source line for backlight driver 20, which is placed through the coupling mechanism 3.

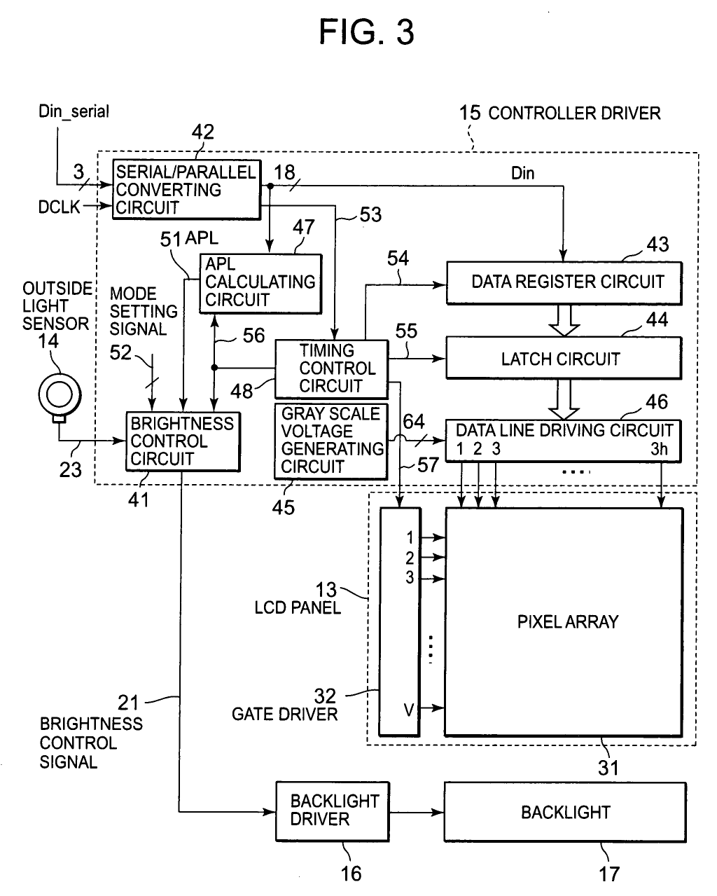

The LCD panel 13 is a display device for displaying an image. As shown in FIG. 3, the LCD panel 13 has a pixel array 31 and a gate driver 32 monolithically integrated. A data line and a gate line are extended to the pixel array 31. A pixel is provided on each intersection of the data line and the gate line. The gate driver 32 drives the gate line provided for the pixel array 31.

Returning to FIG. 2, the outside light sensor 14 measures intensity of the outside light incident on the mobile terminal 10 and generates an outside light intensity signal 23 with a signal level corresponding to the intensity of the outside light. The outside light intensity signal 23 is supplied from the outside light sensor 14 to the controller driver 15. FIG. 2 shows configuration in which the outside light sensor 14 is provided separately from the LCD panel 13, but the outside light sensor 14 may be integrated on the LCD panel 13. The outside light sensor 14 is preferably integrated on the LCD panel 13 when the controller driver 15 is mounted on the glass board of the LCD panel 13 in the COG technique. In such configuration, the outside light sensor 14 can be connected with the controller driver 15 when the controller driver 15 is mounted on the LCD panel 13 in the COG technique.

The controller driver 15 is a device for controlling image display on the LCD panel 13. Specifically, the controller driver 15 has the functions below: First, the controller driver 15 drives the data line of the LCD panel 13 in response to the serial image data Din_serial received from the CPU 11. Second, the controller driver 15 controls the gate driver 32, which is integrated on the LCD panel 13. Additionally, the controller driver 15 generates the brightness control signal 21 and supplies the signal to the backlight driver 16 so as to control the brightness of the backlight 17. In this manner, the controller driver 15 can be configured as a System-in-Package. It is more effective when the controller driver 15 is formed into one chip LSI.

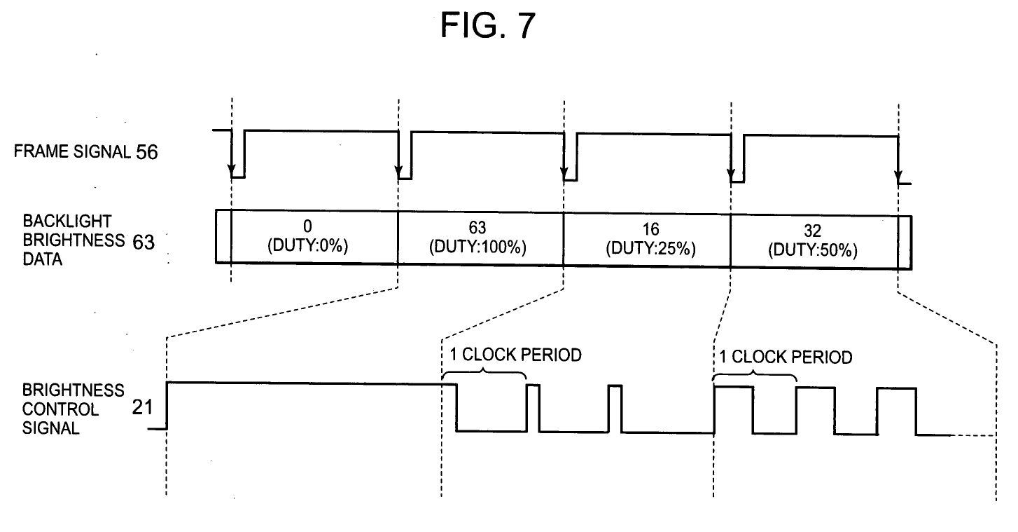

The controller driver 15 has a brightness control circuit 41 in order to control the brightness of the backlight 17. The brightness control circuit 41 generates the brightness control signal 21 in response to the intensity of the outside light measured by the outside light sensor 14 and the serial image data Din_serial. In the embodiment, the brightness control signal 21 is generated by the PWM (pulse width modulation). Specifically, as shown in FIG. 7, the brightness control signal 21 has a pulse waveform. The higher the desired brightness of the backlight 17, the higher the duty ratio of the brightness control signal 21 (i.e., the pulse width of the pulse of the brightness control signal 21). When the brightness of the backlight 17 is the maximum value allowed, the duty ratio of the brightness control signal 21 is set to 100%. When the brightness of the backlight 17 is the minimum value allowed, the duty ratio is set to 0%.

Returning to FIG. 2, the backlight driver 16 drives the backlight 17 in response to the bright control signal 21 supplied from the bright control circuit 41. In the embodiment, an LED is used for the backlight 17, and the backlight driver 16 current drives the backlight 17. Specifically, the backlight driver 16 supplies driving current 22, which has a waveform corresponding to the waveform of the brightness control signal 21, to the backlight 17. The magnitude of the driving current 22 is set to a predetermined current value when the brightness control signal 21 is at “High level”, and set to 0 when the brightness control signal 21 is at “Low level”. The light emitting element for voltage driving may be used as the backlight 17. In that case, the driving voltage is supplied instead of the driving current to the backlight 17.

The abovementioned backlight driver 16, the backlight 17, the interface signal line 18, the power source line for controller driver 19 and the power source line for backlight driver 20 are mounted on an FPC (flexible printed circuit) 24. Generally, a single-layered FPC 24 is used in the mobile terminal because the single-layered FC 24 is superior in flexibility and can reduce the cost of the product. Hereinafter, the FPC 24 used in the specification indicates a single-layered FPC. The FPC 24 is mounted so as to be placed through the coupling mechanism 3 and connected with the PWB (not shown) of the body case 1.

The embodiment of the circuit shown in FIG. 2 is advantageous in that the interface signal line 18 connecting the CPU 11 and the controller driver 15 is resistant to noise. The interface signal line 18 used for transmitting image data by using the fast interface technique is susceptible to noise. In the configuration shown in FIG. 2, however, the controller driver 15 is provided with a function of controlling the brightness of the backlight 17 and the backlight driver 16 is mounted to the display part case 2 that includes the backlight 17. As a result, the power source line for supplying the driving current 22 to the backlight 17 needs not to be arranged along the interface signal line 18. Therefore, in the configuration shown in FIG. 2, the interface signal line 18 is resistant to noise caused by fluctuation of the brightness control signal 21 or the driving current 22. That improves reliability in transmission of the serial image data Din_serial.

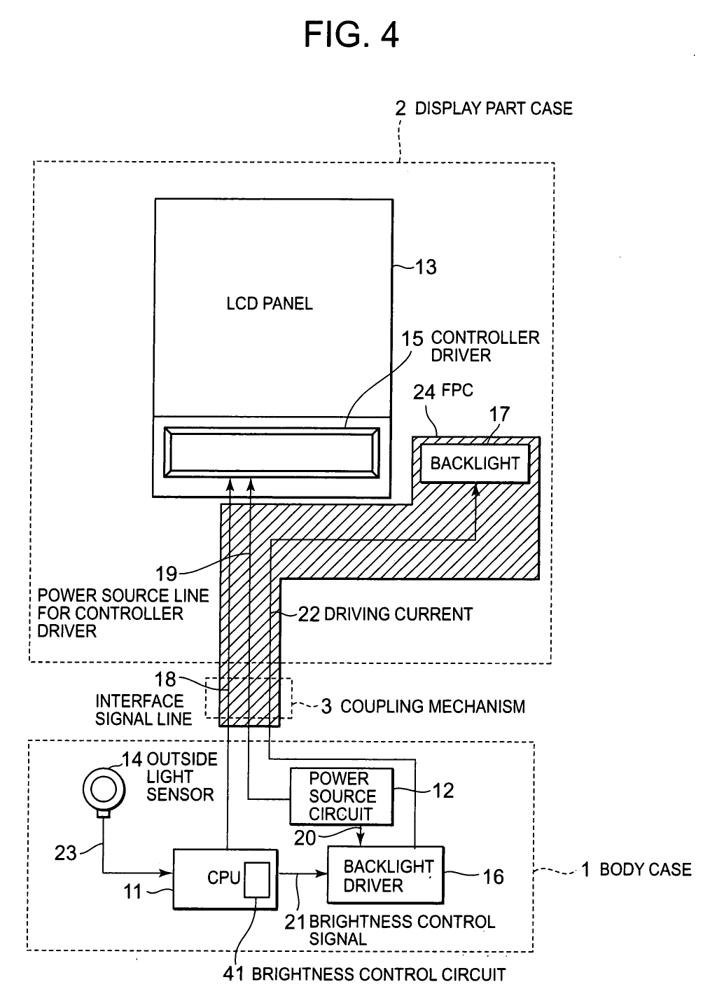

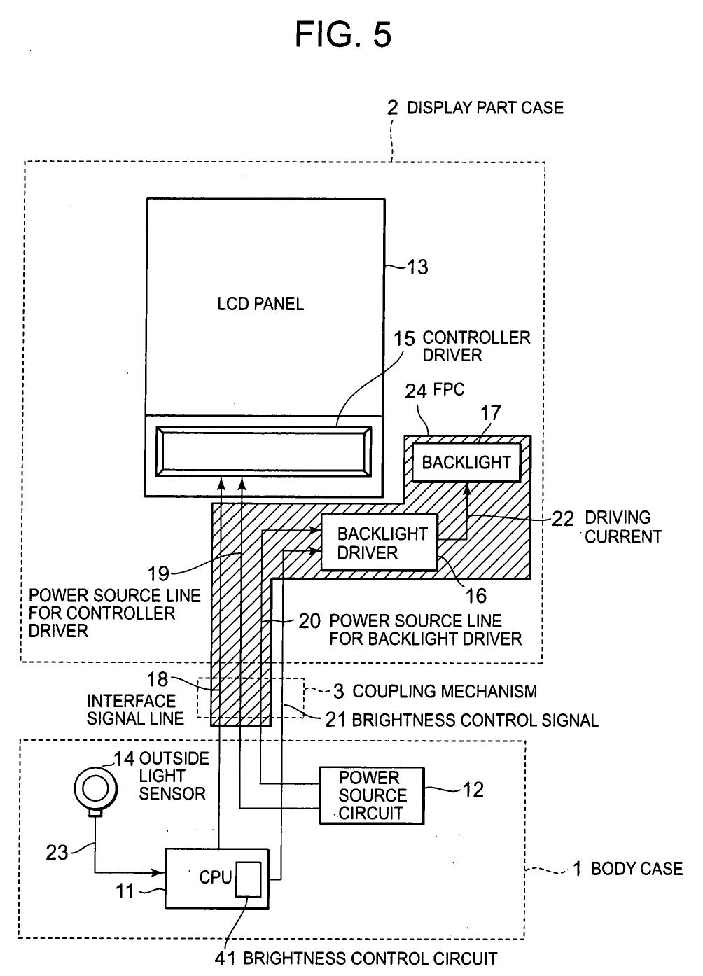

The advantage of the configuration shown in FIG. 2 is more apparent as it is compared with the embodiments of a circuit shown in FIGS. 4 and 5. Configuration in which the CPU 11 is provided with a function of controlling the brightness of the backlight 17 and the outside light sensor 14 and the backlight driver 16 are mounted on the body case 1 that includes the CPU 11 as shown in FIG. 4 will be considered here. In the configuration shown in FIG. 4, the power source line for supplying the driving current 22 to the backlight 17 needs to be arranged across the body case 1 and the display part case 2, i.e., arranged along the interface signal line 18. Such configuration encounters such a trouble as noise is applied to the interface signal line 18 when the driving current 22 fluctuates. That trouble may be approached in a way of arranging the power line for supplying the driving current 22 to the backlight 17 on the FPC 24 at a distant from the interface signal line 18. That approach is not preferable as it limits the layout of the FPC 24.

As shown in FIG. 5, configuration in which the backlight driver 16 is provided in the display part case 2 can also be considered. The configuration shown in FIG. 5, however, is not so much preferable as the configuration of the mobile terminal of the embodiment of the present invention shown in FIG. 2 for the reasons shown below.

First, the configuration shown in FIG. 5, in which the CPU 11 is provided with a function of controlling the brightness of the backlight 17, requires the signal line for transmitting the brightness control signal 21 to be arranged along the interface signal line 18. As mentioned above, the signal level of the brightness control signal 21 fluctuates in controlling the brightness of the backlight 17. Accordingly, arranging the signal line for transmitting the brightness control signal 21 along the interface signal line 18 may cause the interface signal line 18 to be exposed to noise.

Second, the configuration shown in FIG. 5 has more number of signal lines arranged across the body case 1 and the display part case 2 than that in the configuration shown in FIG. 2. In the configuration shown in FIG. 5, the signal line for supplying the brightness control signal 21 to the backlight driver 16 needs to be arranged across the body case 1 and the display part case 2. That increases the number of signal line arranged across the body case 1 and the display part case 2. On the other hand, the configuration shown in FIG. 2 does not need as such. The mobile terminal 10 of the embodiment shown in FIG. 2 may have less number of signal lines arranged across the body case 1 and the display part case 2 than that of the mobile terminal in the configuration shown in FIG. 5.

A function of controlling the brightness of the backlight 17 is provided for the controller driver 15 mounted on the display part case 2. That is one reason to enable the embodiment of the circuit shown in FIG. 2 to be implemented. A general liquid crystal panel driver is not provided with a function of controlling the brightness of the backlight. A CPU controls the brightness of the backlight for the general liquid crystal panel driver, instead. The configuration shown in FIGS. 4 and 5, in which the CPU 11 for generating the serial image data Din_serial is provided with a function of controlling the brightness of the backlight 17, cannot be adapted to arrange neither the power source line for supplying the driving current 22 to the backlight 17 nor the signal line for supplying the brightness control signal 21 to the backlight driver 16 along the interface signal line 18.

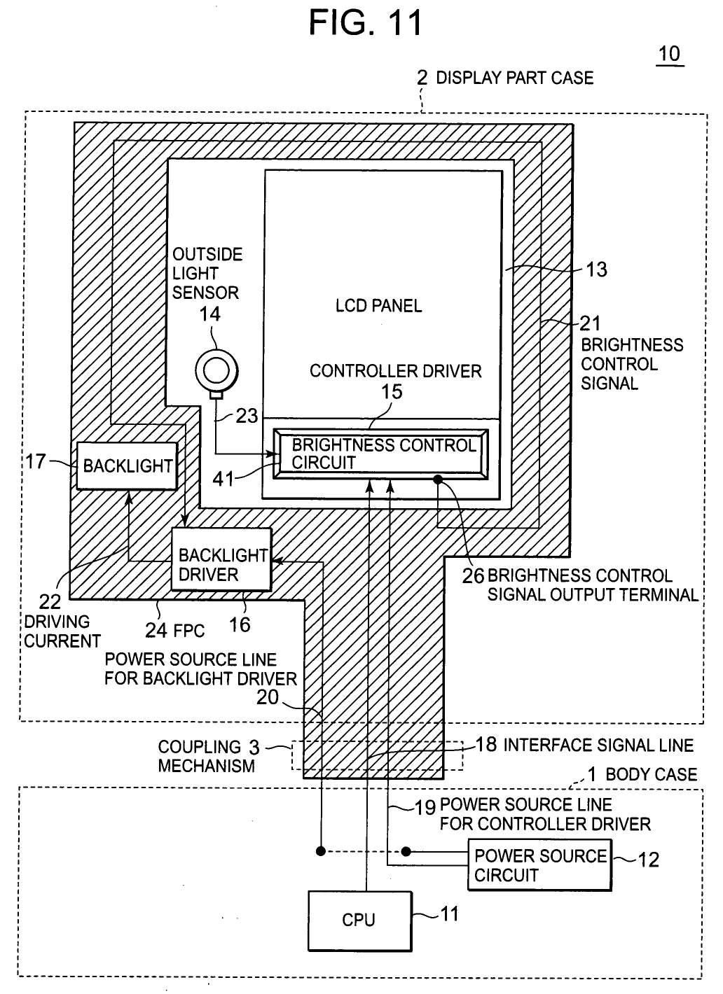

Now, another preferable embodiment will be described. The case, in which the signal line for transmitting the brightness control signal 21 from the controller driver 15 is supplied to the backlight driver 16 in the shortest route without any trouble as shown in FIG. 2, has no problem. The case, in which the backlight 17 and the backlight driver 16 are placed at the opposite side of the brightness control signal output terminal 26 across the interface signal line 18 and driven via the interface signal line 18 and as shown in FIG. 11, has a problem below from the reason of the specification of the mobile terminal. That is, as the mobile terminal uses a single-layered FPC 24, the signal line for transmitting the brightness control signal 21 cannot be arranged from the controller driver 15 across the interface signal line 18. Thus, the signal line needs to be arranged to go around the LCD panel 13 to the backlight driver 16 for the purpose of averting the interface signal line 18. That is not preferable as it requires extra FPCs 24, which has a reverse effect of saving space and increases the cost of the product.

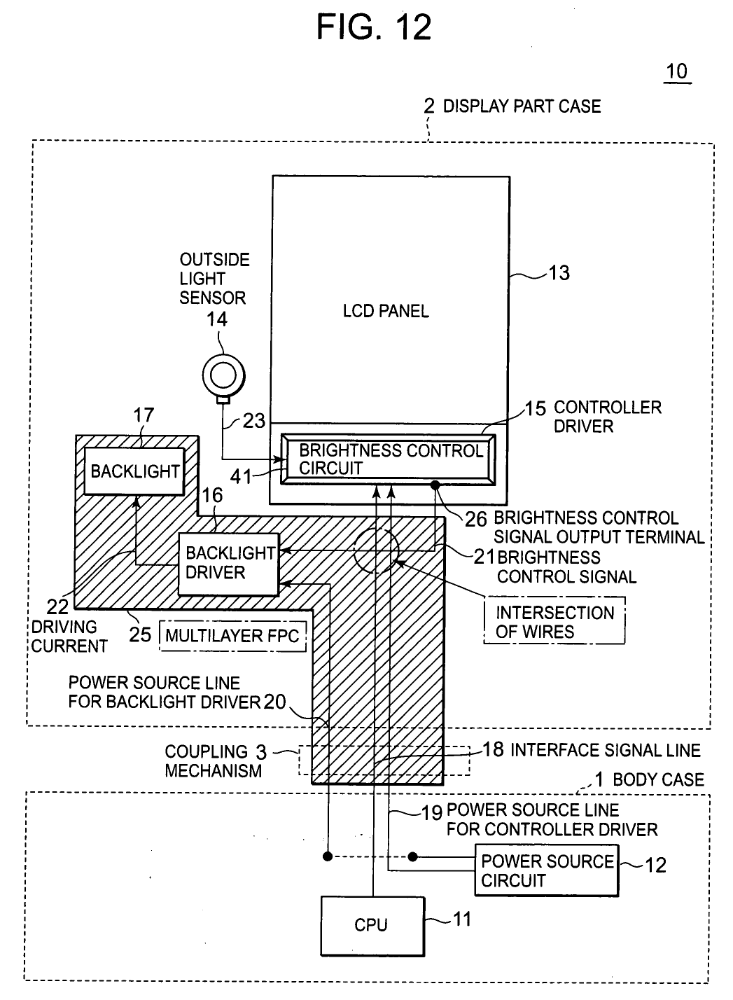

Now, the case in which a multilayer FPC 25 as exemplified in FIG. 12 will be considered. In that case, arrangement of the signal line for transmitting the brightness control signal 21 as shown in FIG. 11 can be avoided. In that case, however, the signal line for transmitting the brightness control signal 21 and the interface signal line 18 cross in the multilayer FPC 25. As a result, that is neither preferable as the line for transmitting the brightness control signal 21 causes the interface signal line 18 to be exposed to noise, similar to the case shown in FIG. 5. Additionally, as that case uses the multilayer FPC 25, bending or folding of the multilayer FPC 25 causes extra stress at the place bent or folded. Furthermore, that using of the multilayer FPC 25 increases the thickness of the FPC, which results in insufficient flexibility provided. Also from the viewpoint of the cost of the product, implementation of the multilayer FPC 25 in the mobile terminal is not practical.

As mentioned above, in the present invention in which the controller driver 15 mounted on the display part case 2 is provided with a function of controlling the brightness of the backlight 17, the backlight driver 16 is limitedly arranged at the side of the brightness control signal output terminal 26 of the controller driver 15 from the interface signal line 18 when the output terminal 26 for transmitting the brightness control signal 21 of the controller driver 15 (hereinafter referred to as the brightness control signal output terminal 26) is arranged at one place.

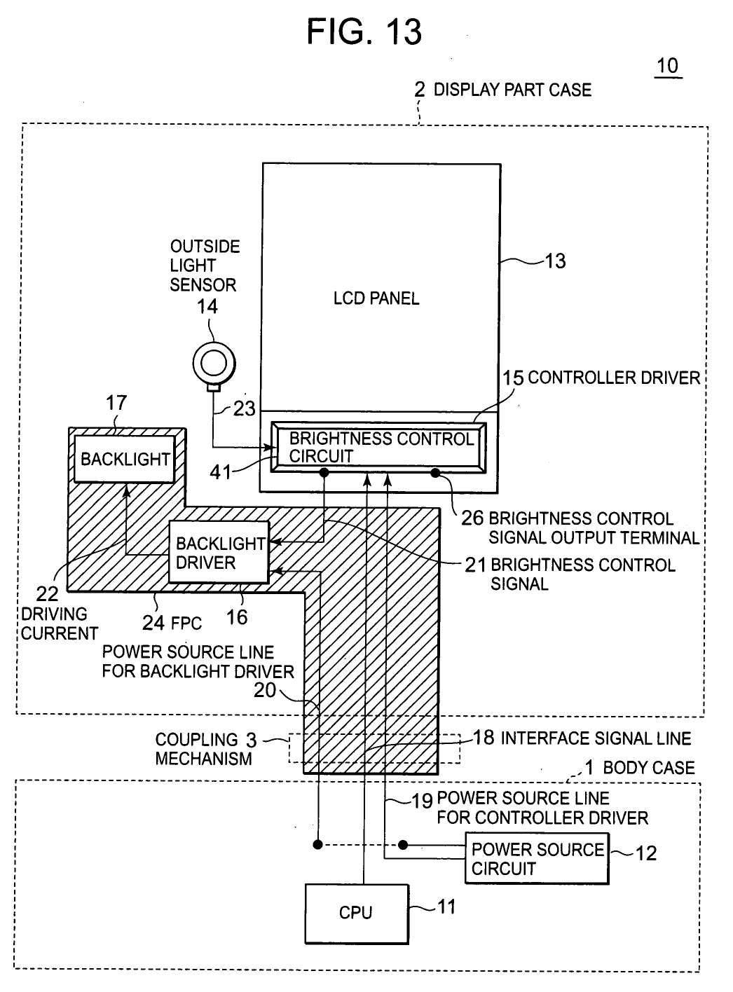

Another preferable embodiment to solve the abovementioned problem is shown in FIG. 13. As it is apparent from FIG. 13, a plurality of the bright control signal output terminal 26 are provided in the present invention. Specifically, the brightness control signal output terminal 26 of the controller driver 15 is provided at each side of the interface signal line 18 on the brightness control circuit. That enables the backlight driver 16 to be arranged without regard of the specification of the mobile terminal. As a result, it only needs to select one of a plurality of brightness control signal output terminal 26 according to the arrangement of the backlight driver 16 and connect it. By taking that way, application of the present invention will be further broadened.

The terminal not to be used among the brightness control signal terminal 26 is open treated and consumes no extra members.

For the configuration for selecting one of the plurality of the brightness control signal output terminals 26, configuration for selecting which terminal of left and right terminals outputs by a register terminal in the controller driver 15 or configuration for always making both terminals to output and selecting only the terminal to use according to the specification of the mobile terminal can be considered.

Now, the specific configuration of the controller driver 15 for realizing the embodiment of the circuit shown in FIG. 2 will be described.

FIG. 3 is a block diagram showing preferable configuration of the controller driver 15. As mentioned above, the controller driver 15 has the brightness control circuit 41 for controlling brightness of the backlight 17. The controller driver 15 also has a serial/parallel converting circuit 42, a data register circuit 43, a latch circuit 44, a grayscale voltage generating circuit 45, a data line driving circuit 46, an APL calculating circuit 47 and a timing control circuit 48.

The serial/parallel converting circuit 42 receives the serial image data Din_serial received from the CPU 11 and converts it into image data Din. The image data Din is parallel data representing a grayscale of each pixel. The serial image data Din_serial is received in sync with a difference clock signal DCLK. The serial/parallel converting circuit 42 also generates a synchronized signal 53 from the difference clock signal DCLK and supplies it to the timing control circuit 48.

The data register circuit 43 latches the image data Din from the serial/parallel converting circuit 42 in order in sync with a register signal 54 supplied from the timing control circuit 48, and temporally saves the latched image data Din. The data register circuit 43 is adapted to be able to store the image data Din by the same number as that of pixels in a line driven by the controller driver 15 (i.e., the number of data lines driven by the controller driver 15). If the controller drier 15 is adapted to drive 384 data lines, the data register circuit 43 is adapted to be able to store 384 pieces of image data Din.

The latch circuit 44 latches the image data Din for one line from the data register circuit 43 in sync with a latch signal 55 supplied from the timing control circuit 48, and transfers the latched image data Din to the data line driving circuit 46.

The grayscale voltage generating circuit 45 generates the voltage (grayscale voltage) corresponding to each of the grayscales that can be taken by pixels of the LCD panel 13 and supplies it to the data line driving circuit 46. In the embodiment, the LCD panel 13 corresponds to the display with 64 grayscales, and accordingly, grayscale voltage is supplied to the data line driving circuit 46 through 64 lines.

The data line driving circuit 46 drives data lines of the LCD panel 13 in response to the image data Din or one line received from the latch circuit 44. Specifically, the data line driving circuit 46 selects the grayscale voltage corresponding to the image data Din among the 64 grayscale voltages for each piece of the image data Din for one line and drives the corresponding data line to the selected grayscale voltage.

The APL calculating circuit 47 calculates APLs (average picture level) 51 of each frame image displayed on the LCD panel 13 from the image data Din output from the serial/parallel converting circuit 42. Specifically, when the APL calculating circuit 47 detects that a frame period started according to a frame signal 56 output from the timing control circuit 48, it sums up the image data Din to be transferred in the frame period. When the transferring of the image data Din in the frame period ends, the APL calculating circuit 47 calculates an average of values of the pieces of image data Din (i.e., a grayscale of each pixel). The calculated average is APL 51. The calculated APL 51 is transmitted to the brightness control circuit 41 and used in controlling brightness of the backlight 17.

The timing control circuit 48 performs timing control on the controller driver 15 and the gate driver 32. Specifically, the timing control circuit 48 generates the register signal 54, the latch signal 55 and the frame signal 56 in sync with the synchronized signal 53 transmitted from the serial/parallel converting circuit 42. With those signals, the timing control circuit 48 controls an operation timing of the brightness control circuit 41, the data register circuit 43, the latch circuit 44 and the APL calculating circuit 47. The timing control circuit 48 also generates a gate driver control signal 57 and controls the operation timing of the gate driver 32.

Now, configuration and operations of the brightness control circuit 41 will be described. The brightness control circuit 41 is adapted to generate the brightness control signal 21 for controlling the brightness of the backlight 17 in response to the outside light intensity signal 23 output from the outside light sensor 14 and the APL (average picture level) 51 of each frame image calculated by the APL calculating circuit 47. The brightness control circuit 41 has a function of making the brightness of the backlight 17 lower as the intensity of the outside light is lower and the APL 51 lower so as to decrease the power consumption of the mobile terminal 10. When the intensity of the outside light is high and/or the APL 51 is high in contrast, the brightness control circuit 41 increases the brightness of the backlight 17 so as to keep the image quality of the frame image in a good state.

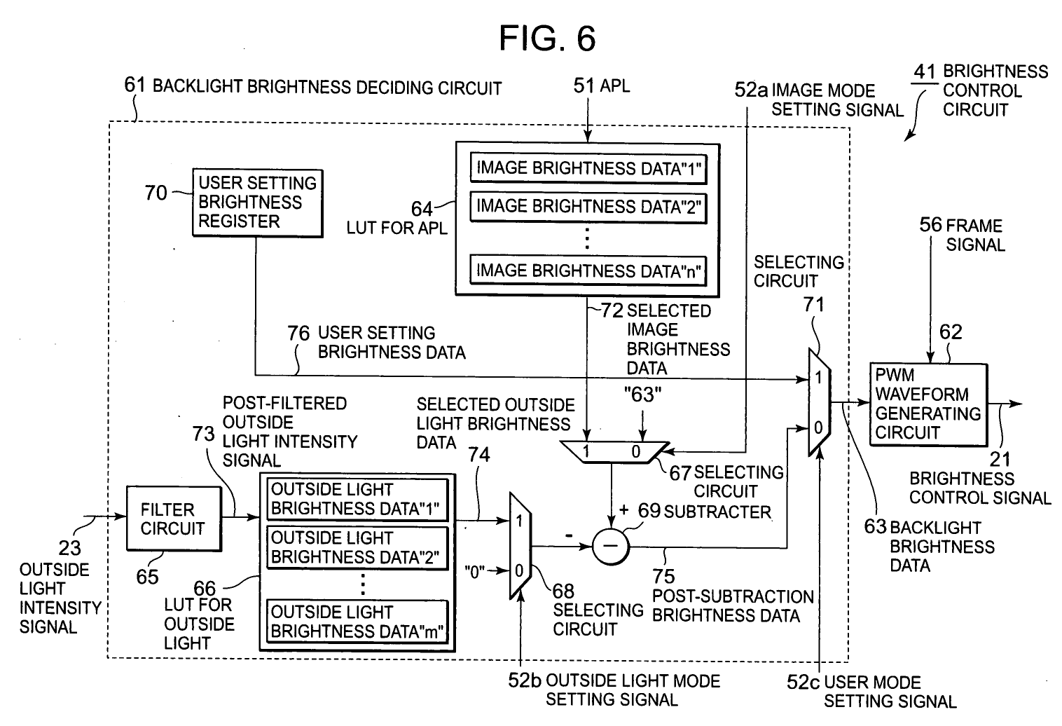

FIG. 6 is a block diagram showing configuration of the brightness control circuit 41 in the embodiment. In the embodiment, the brightness control circuit 41 has a backlight brightness deciding circuit 61 and the PWM waveform generating circuit 62. The backlight brightness deciding circuit 61 generates backlight brightness data 63 according to the outside light intensity signal 23 and the APL 51. The backlight brightness data 63 is data for specifying the brightness of the backlight 17. Operations of the backlight brightness deciding circuit 61 are switched by three mode setting signals 52; an image mode setting signal 52a, an outside light mode setting signal 52b, a user mode setting signal 52c. Values of the image mode setting signal 52a, the outside light mode setting signal 52b and the user mode setting signal 52c are set by the CPU 11.

The PWM waveform generating circuit 62 generates the brightness control signal 21 in response to the backlight brightness data 63. In the embodiment, the PWM waveform generating circuit 62 generates the brightness control signal 21 generated by the PWM (pulse width modulation).

The backlight brightness deciding circuit 61 has an LUT for APL 64, a filter circuit 65, an LUT for outside light 66, a selecting circuits 67 and 68, a subtracter 69, a user setting brightness register 70 and a selecting circuit 71.

The LUT for APL 64 stores a plurality of pieces of image brightness data “1” to “n” and selects a piece of image brightness data (selected image brightness data 72) from the plurality of pieces of image brightness data “1” to “n” in response to the APL 51. Here, the image brightness data is data for deciding the upper limited value for the backlight brightness data 63. The image brightness data, which has the higher value as the APL 51 is higher, is selected as the selected image brightness data 72. In the embodiment, relationship shown below is established in the image brightness data “1” to “n”:

Image brightness data “1”<Image brightness data “2”< . . . < Image brightness data “n”.

In the embodiment, the value of the maximum image brightness data “n” is “63”. Therefore, the upper limited value for the selected image brightness data 72 is “63”.

The LUT for APL 64 is preferably adapted to be rewritable. The rewritable LUT for APL 64 enables easy adjustment of the response of the brightness of the backlight 17 for the luminosity. In the embodiment, the pieces of the image brightness data “1” to “n” are supplied from the CPU 11 to the controller driver 15, and the supplied pieces of image brightness data “1” to “n” are stored in the LUT for APL 64.

The filter circuit 65 generates a post-filtered outside light intensity signal 73 by filtering the outside light intensity signal 23. In the embodiment, a hysteresis filter is used for the filter circuit 65. Usage of the hysteresis filter for the filter circuit 65 is effective in limiting the backlight brightness data 63 to excessively response to fluctuation of the outside light intensity signal 23.

The LUT for outside light 66 stores a plurality of pieces of outside light brightness data “1” to “m”, and selects a piece of outside light brightness data (selected outside light brightness data 74) from the plurality of pieces of outside light brightness data “1” to “m” in response to the APL 51. The outside light brightness data is data that represents the degree that the brightness of the backlight 17 can be reduced. The LUT for outside light 66 selects the outside light intensity data, which has a lower value as the value of the post-filtered outside light intensity signal 73 is higher (i.e., as the intensity of the outside light is higher), as the selected outside light brightness data 74. In the embodiment, relationship shown below is established for the pieces of the outside light brightness data “1” to “m”:

Outside light brightness data “m”<Outside light brightness data “m−1”< . . . < Outside light brightness data “1”.

In the embodiment, the minimum value of the outside light brightness data “m” is “0”. Therefore, the lower limited value for the selected outside light brightness data 74 is “0”.

The LUT for outside light 66 is preferably adapted to be rewritable. The rewritable LUT for outside light 66 enables easy adjustment of the response of the brightness of the backlight 17 for the intensity of the outside light. In the embodiment, the pieces of the outside light brightness data “1” to “n” are supplied from the CPU 11 to the controller driver 15, and the supplied pieces of outside light brightness data “1” to “n” are stored in the LUT for outside light 66.

The selecting circuit 67 outputs either the selected image brightness data 72 or the data value “63” in response to the image mode setting signal 52a. Specifically, the selected image brightness data 72 is selected when the image mode setting signal 52a is the logical “1” and the data value “63” is selected when the image mode setting signal 52a is the logical “0”. As mentioned above, the maximum value of the selected image brightness data 72 is “63”. Therefore, selecting the data value “63” is equal to setting the selected image brightness data 72 to the maximum value without regard of the APL 51.

The selecting circuit 68 outputs either the selected outside light brightness data 74 or the data value “0” in response to the outside light mode setting signal 52b. Specifically, the selected outside light brightness data 74 is selected when the outside light mode setting signal 52b is the logical “1” and the data value “0” is selected when the outside light mode setting signal 52b is the logical “0”. As mentioned above, the minimum value of the selected outside light brightness data 74 is “0”. Therefore, selecting the data value “0” is equal to setting the selected outside light brightness data 74 to the minimum value without regard of the outside light intensity signal 23.

The subtracter 69 generates post-subtraction brightness data 75 by subtracting an output value of the selecting circuit 68 from the output value of the selecting circuit 67.

The user setting brightness register 70 saves the user setting brightness data 76 that indicates the brightness of the backlight 17 specified by a user of the mobile terminal 10. The user setting brightness data 76 is transmitted from the CPU 11 to the controller driver 15 and saved in the user setting brightness register 70.

The selecting circuit 71 selects either the post-subtraction brightness data 75 or the user setting brightness data 76 in response to the user mode setting signal 52c. Specifically, the user setting brightness data 76 is selected when the user mode setting signal 52c is the logical “1” and the user setting brightness data 76 is selected when the user mode setting signal 52c is the logical “0”. The output from the selecting circuit 71 is the abovementioned backlight brightness data 63. The backlight brightness data 63 output from the selecting circuit 71 is supplied to the PWM waveform generating circuit 62.

FIG. 7 is a timing chart showing operations of the PWM waveform generating circuit 62. When the frame signal 56 is activated (in FIG. 7, when the signal is pulled down to a low level), the PWM waveform generating circuit 62 latches the backlight brightness data 63. The PWM waveform generating circuit 62 further generates the brightness control signal 21 so that the signal 21 has the duty ratio according to the value of the backlight brightness data 63. The duty ratio is increased as the value of the backlight brightness data 63 is higher.

The brightness control signal 21 generated in such a manner is used in controlling the backlight driver 16. The backlight driver 16 supplies the driving current 22 to the backlight 17 while the brightness control signal 21 is at the “High” level. The driving current 22 is not supplied to the backlight 17 while the brightness control signal 21 is at the “Low” level. Therefore, the bigger the duty ratio of the brightness control signal 21, i.e., the bigger the value of the backlight brightness data 63, the longer period the backlight 17 is lit, which increases the brightness of the backlight 17.

The brightness control circuit 41 has four operation modes shown below. Operation modes are switched by the image mode setting signal 52a, the outside light mode setting signal 52b and the user mode setting signal 52c.

(1) User Setting Mode

Now, refer to FIG. 6. As the user mode setting signal 52c is set to the logical “1”, the brightness control circuit 41 can be set to the user setting mode. The user setting mode is an operation mode for lighting the backlight 17 with the brightness specified by the user. Values of the image mode setting signal 52a and the outside light mode setting signal 52b can be any values.

Specifically, the selecting circuit 71 selects the user setting brightness data 76 as the backlight brightness data 63 when the user mode setting signal 52c is set to the logical “1”. The backlight 17 is lit with the brightness specified by the backlight brightness data 63. According to the operation, the backlight 17 can be lit with the brightness specified by the user.

(2) Image Setting Mode

As the image mode setting signal 52a is set to the logical “1” and the outside light mode setting signal 52b and the user mode setting signal 52c are set to the logical “0”, the brightness control circuit 41 can be set to the image setting mode. The image setting mode is the operation mode in which the brightness of the backlight 17 is controlled in accordance with the APL 51 of the frame image (without regard of the intensity of the outside light).

Specifically, the selected image brightness data 72 is selected from the pieces of the image brightness data “1” to “n” according to the APL 51 calculated by the APL calculating circuit 47. In response to the fact that the image mode setting signal 52a is the logical “1”, the selected image brightness data 72 is output from the selecting circuit 67 to the subtracter 69. On the other hand, in response to the fact that the outside light mode setting signal 52b is the logical “0”, the data “0” is output from the selecting circuit 68 to the subtracter 69. The value of the post-subtraction brightness data 75 output from the subtracter 69 matches the value of the selected image brightness data 72. In response to the fact that the user mode setting signal 52c is set to the logical “0”, the selecting circuit 71 selects the post-subtraction brightness data 75 as the backlight brightness data 63. As a result, the backlight brightness data 63 matches the selected image brightness data 72. The backlight 17 is lit with the brightness specified by the backlight brightness data 63. According to the operations, the brightness of the backlight 17 is controlled according to the APL 51.

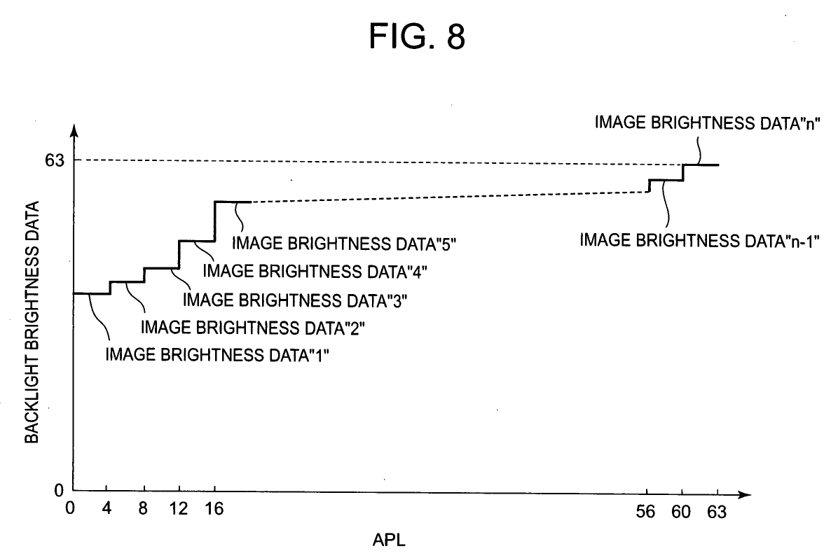

FIG. 8 is a graph showing relationship between the APL 51 and the backlight brightness data 63 when the brightness control circuit 41 is set to the image setting mode. When the APL 51 is low, i.e., when the frame image is dark, the backlight brightness data 63 is reduced so that the brightness of the backlight 17 is lowered. When the frame image is dark, the image quality of the frame image is not lowered even if the brightness of the backlight 17 is lowered. The lowering of the brightness of the backlight 17 is rather preferable as it lowers the power consumption. When the APL 51 is high in contrast, the brightness of the backlight 17 is increased and the frame image is displayed in a good image quality.

(3) Outside Light Setting Mode

As the outside light mode setting signal 52b is set to the logical “1” and the image mode setting signal 52a and the user mode setting signal 52c are set to the logical “0”, the brightness control circuit 41 can be set to the outside light setting mode. The outside light setting mode is the operation mode in which the brightness of the backlight 17 is controlled in accordance with the outside light intensity (without regard of the APL 51).

Specifically, the data “63” is output from the selecting circuit 67 to the subtracter 69 according to the fact that the image mode setting signal 52a is the logical “0”. On the other hand, the selected outside light brightness data 74 is selected from the pieces of the outside light brightness data “1” to “m” according to the outside light intensity signal 23 (i.e., according to the intensity of the outside light), and further, the selected outside light brightness data 74 is output from the selecting circuit 68 to the subtracter 69 according to the fact that the outside light mode setting signal 52b is the logical “1”. The value of the post-subtraction brightness data 75 output from the subtracter 69 is the value obtained by subtracting the value of the selected outside light brightness data 74 from the data “63”. The selecting circuit 71 selects the post-subtraction brightness data 75 as the backlight brightness data 63 according to the fact that the user mode setting signal 52c is set to the logical “0”. As a result, the backlight brightness data 63 is the value obtained by subtracting the value of the selected outside light brightness data 74 from the data “63”. The backlight 17 is lit with the brightness specified by the backlight brightness data 63. According to the operations, the brightness of the backlight 17 is controlled in accordance with the intensity of the outside light.

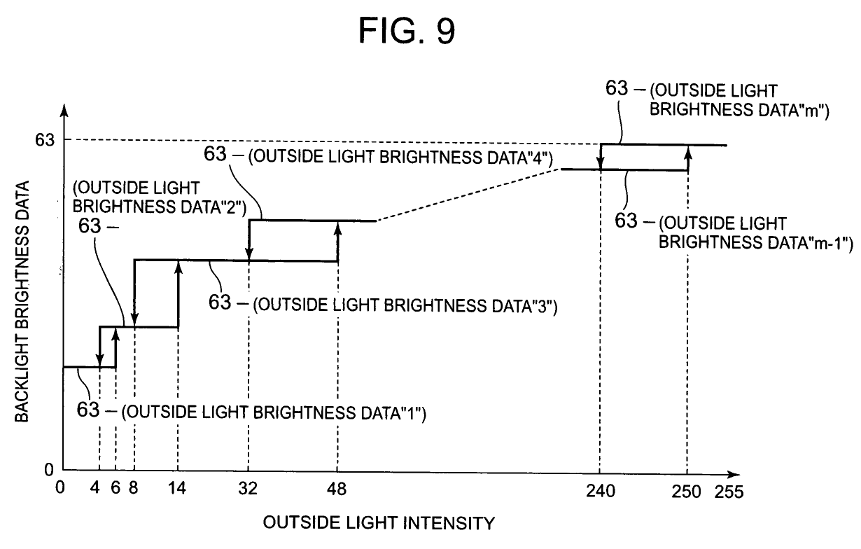

FIG. 9 is a graph showing relationship between the outside light intensity and the backlight brightness data 63 when the brightness control circuit 41 is set to the outside light setting mode. In the embodiment, the outside light shown by the outside light intensity signal 23 is digitized in 256 stages. When the intensity of the outside light is low, the backlight brightness data 63 is reduced so that the brightness of the backlight 17 is lowered. When the intensity of the outside light is low, the image quality of the frame image is not lowered even if the brightness of the backlight 17 is lowered. The lowering of the brightness of the backlight 17 is rather preferable as it lowers the power consumption. When the intensity of the outside light is high in contrast, the brightness of the backlight 17 is increased and the frame image is displayed in a good image quality. The graph shown in FIG. 9 includes hysteresis as a hysteresis filter is used as the filter circuit 65.

(4) Image/Outside Light Setting Mode

As the image mode setting signal 52a and the outside light setting signal 52b are set to the logical “1” and the user mode setting signal 52c is set to the logical “0”, the brightness control circuit 41 can be set to the image/outside light setting mode. The image/outside light setting mode is the operation mode in which the brightness of the backlight 17 is controlled in accordance with the APL 51 and the intensity of the outside light.

Specifically, the selected image brightness data 72 is selected from the pieces of the image brightness data “1” to “n” according to the APL 51 calculated by the APL calculating circuit 47, and the selected outside light brightness data 74 is selected from the pieces of the outside light brightness data “1” to “m” according to the outside light intensity signal 23 (i.e., according to the intensity of the outside light). Further, in response to the fact that both the image mode setting signal 52a and the outside light mode setting signal 52b are the logical “1”, the selected image brightness data 72 and the selected outside light brightness data 74 are output from the selecting circuits 67 and 68 to the subtracter 69 respectively. The value of the post-subtraction brightness data 75 output from the subtracter 69 is the value obtained by subtracting the value of the selected outside light brightness data 74 from the value of the selected image brightness data 72. Further, in response to the fact that the user mode setting signal 52c is set to the logical “0”, the selecting circuit 71 selects the post-subtraction brightness data 75 as the backlight brightness data 63. As a result, the backlight brightness data 63 is the value obtained by subtracting the value of the selected outside light brightness data 74 from the value of the selected image brightness data 72. The backlight 17 is lit with the brightness specified by the backlight brightness data 63. According to the operations, the brightness of the backlight 17 is controlled in accordance with the APL 51 and the intensity of the outside light.

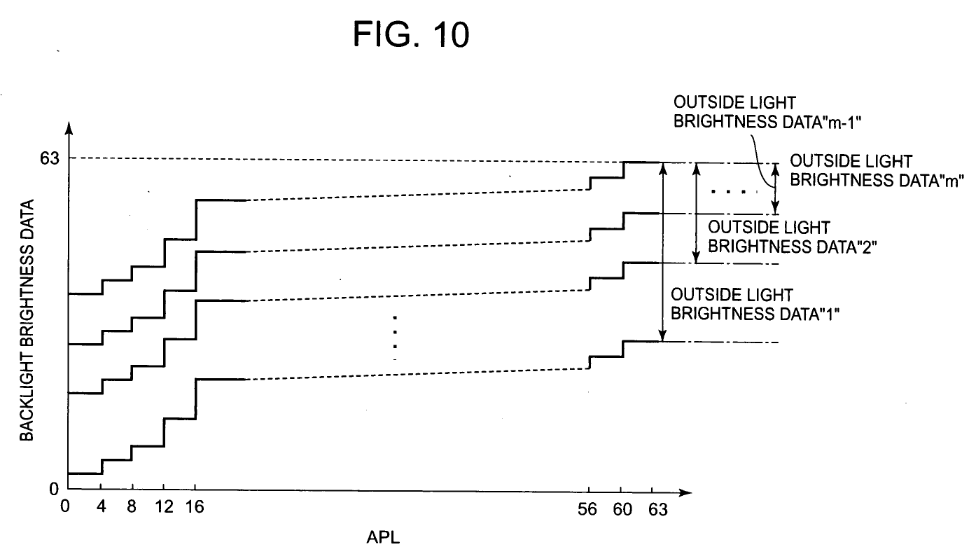

FIG. 10 is a graph showing relationship between the APL 51 and the intensity of the outside light when the bright control circuit 41 is set to the image/outside light setting mode. The graph shown in FIG. 10 includes hysteresis as a hysteresis filter is used as the filter circuit 65. The graph of the backlight brightness data 63 in the image/outside light setting mode is the graph of the APL 51 and the backlight brightness data 63 shown in FIG. 8 shifted in the vertical direction according to the selected outside light brightness data 74. As the brightness control circuit 41 is set in the image/outside light setting mode in such a manner, the value of the backlight brightness data 63, i.e., the brightness of the backlight 17 is controlled depending on both the APL 51 and the outside light intensity.

As described above, in the mobile terminal 10 of the embodiment, the controller driver 15 mounted to the display part case 2 is provided with a function of generating the brightness control signal 21 for controlling the brightness of the backlight 17. Accordingly, neither the power source line for supplying the driving current 22 along the interface signal line 18, which connects the CPU 11 and the controller driver 15, nor the signal line for transmitting the brightness control signal 21 needs to be provided. That effectively improves the reliability of transmission of the image data from the CPU 11 to the controller driver 15. The controller driver 15 generates the brightness control signal 21 according to the image data/the intensity of the outside light of each frame image and realizes proper control on the brightness of the backlight 17.

The method for controlling the brightness of the backlight 17 according to the APL 51 of each frame image is disclosed in the abovementioned embodiment, though, the processing of the image data of each frame image is not limited to the calculation of the APL 51. For example, the histogram of the image data of each frame image may be created so that the brightness of the backlight 17 is controlled in accordance with the histogram.

What is claimed is:

1. A mobile terminal comprising:
a first case;
a second case;
a coupling mechanism for movably coupling said first case and said second case;
an image data generating part for generating image data;
a display panel;
a display panel driver for driving said display panel;
a backlight for illuminating said display panel; and
a driving circuit for driving said backlight;
wherein said image data generating part is mounted on said first case, and
said display panel, said display panel driver, said backlight and said driving circuit are mounted on said second case;
said display panel driver receives said image data from said image data generating part via a signal line extending through said coupling mechanism to drive said display panel in response to said received image data while supplying a brightness control signal for controlling the brightness of said backlight to said driving circuit.

2. The mobile terminal according to claim 1, wherein
said display panel driver generates said brightness control signal in response to said image data.

3. The mobile terminal according to claim 1, further comprising
an outside light sensor for generating an outside light intensity signal in accordance with intensity of outside light; wherein
said display panel driver generates said brightness control signal in response to said outside light intensity signal.

4. The mobile terminal according to claim 3, wherein
said outside light sensor is mounted on said second case.

5. The mobile terminal according to claim 3, wherein
said display panel driver generates said brightness control signal further in response to said image data.

6. The mobile terminal according to claim 5, wherein
said display panel driver comprises:
an image brightness data generation circuit coupled to receive said image data to generate image brightness data with a higher value for a brighter image;
an outside light brightness data generation circuit coupled to said sensor to generate outside light brightness data with a lower value for a higher intensity of said outside light;
a backlight brightness data generation circuit coupled to said image brightness data generation circuit and said outside light brightness data generation circuit to generate backlight brightness data indicating the brightness of said backlight in response to a remainder obtained by subtracting said outside light brightness data from said image brightness data; and
a brightness control signal generation circuit coupled to said backlight brightness data generation circuit to generate said brightness control signal in response to said backlight brightness data.

7. A display panel driver comprising:
a display panel driving circuit to drive a display panel in response to image data received from outside; and
a brightness control circuit provided adjacent to said driving circuit to generate a brightness control signal that controls brightness of a backlight for illuminating said display panel.

8. The display panel driver according to claim 7, wherein
said brightness control circuit controls the brightness of the backlight in response to said image data.

9. The display panel driver according to claim 7, wherein
said brightness control circuit receives an outside light intensity signal from an outside light sensor in accordance with intensity of an outside light, and generates said brightness control signal in response to said outside light intensity signal.

10. The display panel driver according to claim 9, wherein
said brightness control circuit generates said brightness control signal further in response to said image data.

11. The display panel driver according to claim 10, wherein
said brightness control circuit comprises:
an image brightness data generation circuit coupled to receive said image data to generate image brightness data with a higher value for a brighter image;
an outside light brightness data generation circuit coupled to said sensor to generate outside light brightness data with a lower value for a higher intensity of said outside light;
a backlight brightness data generation circuit coupled to said image brightness data generation circuit and said outside light brightness data generation circuit to generate backlight brightness data indicating the brightness of said backlight in response to a remainder obtained by subtracting said outside light brightness data from said image brightness data; and
a brightness control signal generation circuit coupled to said backlight brightness data generation circuit to generate said brightness control signal in response to said backlight brightness data.

12. The mobile terminal according to claim 1, wherein
said display panel driver comprises a plurality of electric terminals for supplying said brightness control signal.

13. The mobile terminal according to claim 12, wherein
said display panel driver is adapted to select an electric terminal from said plurality of electric terminals and supply the brightness control signal to said driving circuit.

14. The mobile terminal according to claim 13, wherein
said display panel driver is adapted to select an electric terminal from said plurality of electric terminals so that said signal line and a signal line for transmitting said brightness control signal do not cross, and supply the brightness control signal to said driving circuit.

15. The mobile terminal according to claim 12, wherein
said plurality of electric terminals are placed on both sides of said signal line through which said image data is transferred.

16. The mobile terminal according to claim 13, wherein
said display panel driver is adapted to select an electric terminal from said plurality of electric terminals according to a desired arrangement of said driving circuit.

17. The display panel driver according to claim 7, wherein
said display panel driver is formed into one package, and said brightness control circuit comprises a plurality of electric terminals for sending out said brightness control signal to outside of said package.

18. The display panel driver according to claim 17, wherein
said display panel driver selects an electric terminal from said plurality of electric terminals and sends out said brightness control signal from selected one electric terminal to outside.

19. The display panel driver according to claim 17, wherein
said plurality of electric terminals are placed on both sides of an input terminal of said image data.

20. The display panel driver according to claim 7, comprising
a plurality of electric terminals for outputting said brightness control signal to outside.
